(19) United States
(12) Patent Application Publication
(10) Pub. No.: US 2005/0106922 A1
(43) Pub. Date: May 19, 2005

(54) Land grid array socket having improved load plate

(75) Inventor: Hao-Yun Ma, Tu-Chen (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 10/982,419

(22) Filed: Nov. 5, 2004

(30) Foreign Application Priority Data
Nov. 14, 2003 (TW) 92220214

(51) Int. Cl. H01R 13/62

(52) U.S. Cl. 439/331

(57) ABSTRACT

A land grid array socket is provided which includes an insulative housing (2) forming a space to receive an IC chip therein and a reinforce plate (3) surrounding periphery of the housing. A load plate (5) is pivotally connected to the reinforce plate which comprises a pressing portion (53) applying a downwardly pressing force on the IC chip when the socket is at a closed state, and the pressing portion forms a contacting surface integrally pressing down to the IC chip so as to provide sufficient pressing force to the IC chip.

### BACKGROUND OF THE INVENTION

1. Field of the Invention

The present invention relates to the art of electrical connectors, and more particularly to a land grid array (LGA) socket having a load plate for positioning an IC chip in the LGA socket.

2. The Prior Art

Referring to FIG. 4, a conventional LGA socket is illustrated. The LGA socket comprises an insulative housing 2′ having a plurality of electronic terminals (not shown in the FIG.) arrayed therein for electrically connecting an IC chip 3 and a metallic reinforce plate 4′ wrapping periphery of the housing 2′ to reinforcing the housing 2′. A lever 6′ is pivotally attached to one side of the reinforce plate 4′ and a load plate 5′ is pivotally attached to another side of the reinforce plate 4′ opposite to the lever 6′, both the lever 6′ and the load plate 5′ can rotate between an open position where the IC chip 3 can be put onto the housing 2′ and a closed position where the IC chip 3 is locked to establish electrical connection with the terminals in the housing 2′.

FIG. 5 shows the LGA socket of FIG. 4 is at a closed state where the lever 6′ and the load plate 5′ all rotate to their closed position. A pressing portion 53′ of the load plate 5′ resists a top surface 30 of the IC chip 3 so as to position the IC chip 3 onto the housing 2′, and a contacting point C′ is formed on the pressing portion 53′ which is settled substantially at a middle of the housing 2′ where a downwardly pressing force N′ is generated from the pressing portion 53′ to the housing 2′. Since the load plate 5′ is pivotally attached to the metallic reinforce plate 4′, the load plate 5′ often suffers from a slightly horizontal slide tendency with respect to the housing 2′ along a direction H, which will cause the IC chip 3 to apply a horizontal pressing force to a side wall B′ of the housing 2′. As a result, an upwardly friction force F′ will be applied to the IC chip 3 from the side wall B of the housing 2′ during pressing down of the IC chip 3 onto the housing 2′, the friction force might cause the IC chip 3 to rotation upwardly with respect to another side wall A of the housing 2′ such that a part of the IC chip 3 can not be completely pressed down to its full electrical connection position. Therefore, failure of electrical connection between the IC chip 3 and the electronic terminals in the housing 2′ become possible, this risk is strictly prohibited.

### SUMMARY OF THE INVENTION

Accordingly, a main object of the present invention is to provide an land grid array (LGA) socket having an improved load plate, wherein the load plate enhance the safety of electrical connection between an IC chip and electrical terminals in the LGA socket.

To fulfill the above-mentioned object, a land grid array socket in accordance with the present invention is provided. The socket comprises an insulative housing, a reinforce plate and an improved load plate The housing forms a space for receiving an IC chip therein, and a plurality of electrical terminal are accommodated in the housing for establishing electrical connection with the IC chip. The reinforce plate attached to periphery of the housing and the load plate is pivotally connected to the reinforce plate which has a pressing portion applying a downwardly pressing force on the IC chip so as to position the IC chip in the space. Further, a part of the pressing portion forms a contacting surface integrally pressing a top surface of the IC chip and a furthest contacting point on the contacting surface is closer to a connecting portion of the load plate and further to the locking portion so as to provide a sufficient pressing force to ensure safe electrical connection between the IC chip and the terminals.

### BRIEF DESCRIPTION OF THE DRAWINGS

FIG. 1 is an exploded perspective view of a land grid array (LGA) socket in accordance with a preferred embodiment of the present invention and an IC chip.

FIG. 2 is an assembled perspective view of the LGA socket of FIG. 1, with a load plate of the LGA socket at an open position and the IC chip is adapted to be positioned in the LGA socket.

FIG. 3 is a cross-sectional view taken along line III-III of FIG. 2.

FIG. 4 is an exploded perspective view of a conventional land grid array (LGA) socket

FIG. 5 is a cross-sectional view taken along line V-V of FIG. 4.

### DETAILED DESCRIPTION OF PREFERRED EMBODIMENT

Reference will now be made to the drawings to describe the present invention in detail.

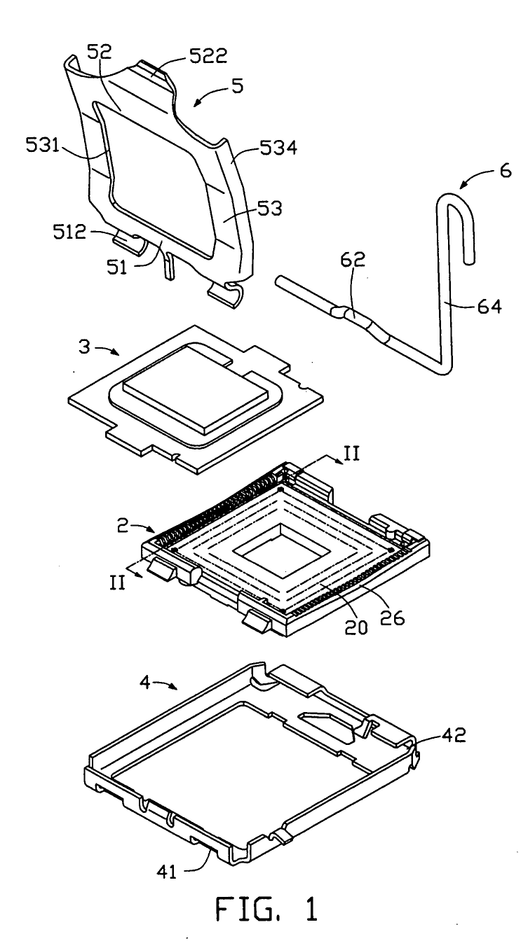

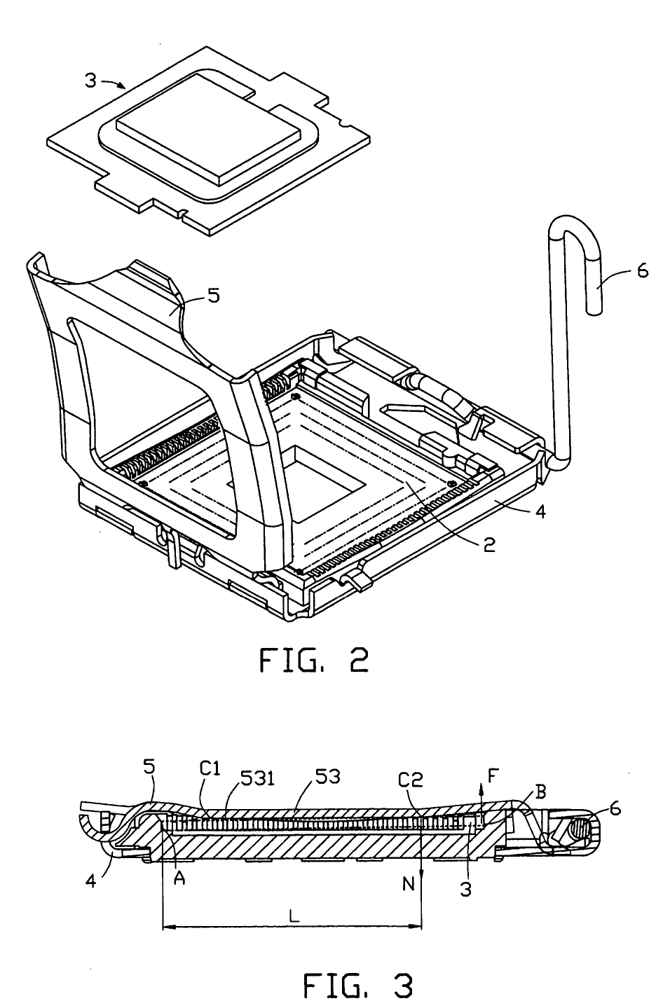

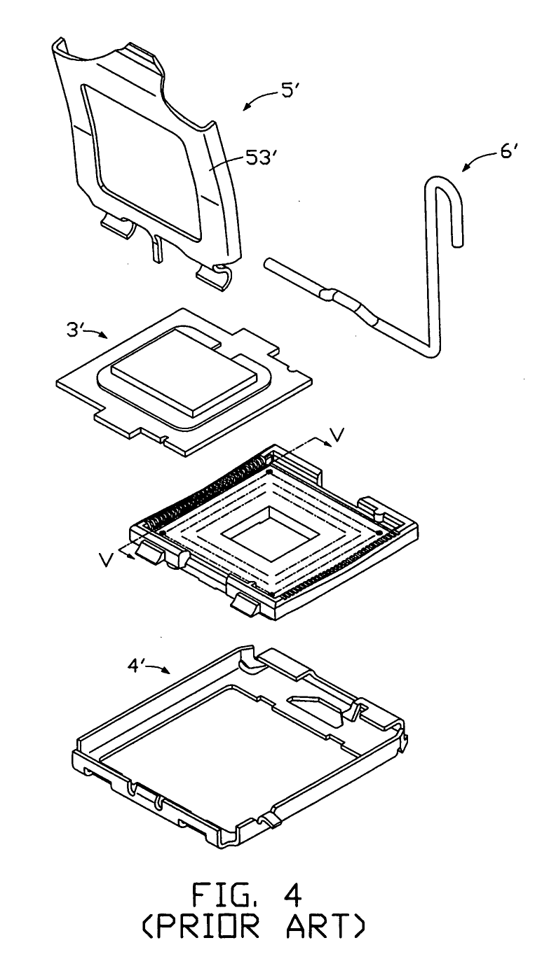

Referring to FIGS. 1 and 2, a land grid array (LGA) socket in accordance with a preferred embodiment of the present invention is illustrated. The LGA socket comprises a metallic reinforce plate 4, an insulative housing 2 received in a space 40 of the reinforce plate 4 which wraps periphery of the housing 2, a metallic load plate 5 pivotally connected to one side 41 of the reinforce plate 4, and a lever 6 pivotally connected to an opposite side 42 of the reinforce plate 4. The load plate 5 and the lever 6 all can rotate between an open potion (FIG. 2) where an IC chip 3 can be put into a receiving space 20 of the housing 2 and a closed position (FIG. 3) where the load plate 5 is locked by the lever 6 and applies a downwardly pressing force on a top surface 30 of the IC chip 3.

The housing 2 comprises two side wall 26 and two end walls A and B (FIG. 3), the side walls 26 and the end walls A and B surrounding the receiving space 20 for accommodating the IC chip 3 therein and the end walls have several locating projections formed thereon and projection toward the space 20 for aiding location of the IC chip 3 to its true position in the space 20.

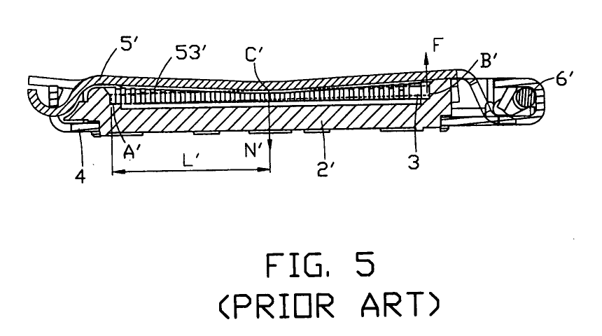

The load plate 5 has a central opening surrounding by a connecting portion 51, a pair of pressing portions 53 and a locking portion 52. The connecting portion 51 forms a pair of latches 512 which are connected to the side 41 of the reinforce 4 and can pivotally rotate with respect to the side 41. The locking portion 52 forms a locking end 522 which can be pressed and locked by a locking shaft 62 of the lever 6 when the lever 6 rotates to its closed position (FIG. 3) under driving of a driving shaft 64. The pressing portion 53 interconnects the connecting portion 51 and the locking portion 52, a flange 534 bends vertically from the pressing portion 53 which increases the solidity of the pressing portion such that the pressing portion 53 can provide a sufficient pressing force to the IC chip 3. A middle part of the pressing portion 53 protrudes integrally toward the IC chip and forms an contacting surface 531, the contacting surface 531 integrally contacts with a top surface 30 of the IC chip 3 when the load plate 5 is at its closed position. Referring to FIG. 3, the contacting surface 531 has a nearest contacting point C1 with respect the connecting portion 51 and a furthest contacting point C2 with respect the connecting portion 51, a distance L between the contacting point C2 and the end wall A of the housing 2 is longer than a distance L′ between the contacting point C′ and the end wall A′ of the housing 2′ as shown in FIG. 5. Therefore, if the pressing force N applied to the IC chip 3 from the contacting point C2 is equal to the pressing force N′ applied to the IC chip 3 from the contacting point C′, the tendency of the IC chip 3 rotates upwardly with respect to the end wall A under the friction force F will smaller comparing with the tendency of rotation as disclosed in FIG. 5. As a result, failure of electrical connection between the IC chip 3 and the electronic terminals in the housing 2 is avoided.

A preferred embodiment in accordance with the present invention has been shown and described. However, in another alternative embodiment, the contacting surface 531 can be modified to a single pressing line or a pressing protrusion, if only the furthest contacting point C2 is settled to be closer to the connecting portion 51 but further to the locking portion 52. Therefore, equivalent modifications and changes known to persons skilled in the art according to the spirit of the present invention are considered within the scope of the present invention as defined in the appended claims.

1. An electrical connector adapted to receive an IC chip therein, the connector comprising:
an insulative housing having a space for receiving the IC chip, a plurality of electrical terminal being accommodated in the housing for establishing electrical connection with the IC chip;
a reinforce plate attached to periphery of the housing;
a load plate comprising a connecting portion pivotally connected to one side of the reinforce plate, a locking portion adapted to be locked to the reinforce plate by a lever and a pressing portion formed between the connecting portion and the locking portion and applying a downwardly pressing force to the IC chip, and wherein a contacting point is formed on the pressing portion where the pressing force is applied to the IC chip, the contacting point being closer to the locking portion but further to the connecting portion.

2. The electrical connector of claim 1, wherein the load plate comprises a pair of spaced pressing portions, each pressing portion having at least one contacting point formed thereof.

3. The electrical connector of claim 2, wherein each pressing portion has only one contacting point formed thereof, the contacting point being closer to the locking portion but further to the connecting portion.

4. The electrical connector of claim 2, wherein each pressing portion has two spaced contacting points formed thereof.

5. The electrical connector of claim 4, wherein a part of the pressing portion between the two contacting points forms a contacting surface which integrally contacts with a top surface of the IC chip.

6. The electrical connector of claim 1, wherein the lever is pivotally connected to another side of the reinforce plate opposite to the side where the load plate is connected to the reinforce plate.

7. A land grid array socket, comprising:
an insulative housing forming a space for receiving an IC chip therein, a plurality of electrical terminal being accommodated in the housing for establishing electrical connection with the IC chip;
a reinforce plate attached to periphery of the housing;
a load plate pivotally connected to the reinforce plate having a pressing portion which applies a downwardly pressing force on the IC chip; and wherein a part of the pressing portion forms a contacting surface integrally pressing a top surface of the IC chip such that proving a sufficient pressing force to ensure safe electrical connection between the IC chip and the terminals.

8. The socket of claim 7, wherein the insulative housing has side walls and end walls surrounding the space and the IC chip resists the end walls when it is received in the space.

9. The socket of claim 7, wherein the load plate comprises a connecting portion pivotally connected to one side o the reinforce plate and a locking portion formed a free end thereof, the pressing portion being formed between the connecting portion and the locking portion.

10. The socket of claim 9, wherein the socket further comprises a lever pivotally connected to another side of the reinforce plate opposite to the load plate, and the lever cooperates with the locking portion of the load plate.

11. The socket of claim 9, where the contact surface is settled between two contacting points of the pressing portion, and at least one of the contacting points is closer to the locking portion and further to the connecting portion.

12. A socket assembly comprising:
an insulative housing having a space;
an electronic package received in the space;
a plurality of electrical terminal being accommodated in the housing with upper contacting portions upwardly extending into the space;
a reinforce plate attached to periphery of the housing;
a load plate defining a lengthwise direction and comprising a connecting portion pivotally connected to one lengthwise end of the reinforce plate, a locking portion adapted to be locked around the other lengthwise end of the reinforce plate by a lever, an imaginary centerline of said load plate defined equidistantly between said two ends and extending in a transverse direction perpendicular to said lengthwise direction; and
at least two spaced contacting points formed on an underside of the load plate to downwardly press against an upper face of the electronic package, respectively; wherein
said two spaced contacting points are respectively located by two sides of said centerline of said load plate

13. The socket assembly as claimed in claim 12, wherein a distance between said two contacting points is around one third of a full length of said load plate in said lengthwise direction.

14. The socket assembly as claimed in claim 12, wherein a distance between said two contacting points is not less than one fourth of the full length of said load plate in said lengthwise direction.
